(19) United States
(12) Patent Application Publication
(10) Pub. No.: US 2006/0093481 A1
(43) Pub. Date: May 4, 2006

(54) Combination type fan leaves structure

(75) Inventor: Chen Hui Lai, Taipei Hsien (TW)

Correspondence Address: BIRCH STEWART KOLASCH & BIRCH, PO BOX 747, FALLS CHURCH, VA, 22040-0747, US

(73) Assignee: POWER COOLER ENTERPRISE CO., LTD.

(21) Appl. No.: 10/979,174

(22) Filed: Nov. 3, 2004

(51) Int. Cl. F03D 1/02

(52) U.S. Cl. 416/120

(57) ABSTRACT

A combination type fan leaves structure comprise a upper fan leaves component and lower leaves component; the leaves of the upper and lower leaves components are interlaced to combine into a high density leaves structure. Therefore, the mold release is easier so as to be contributive to the production of the fan leaves.

### BACKGROUND OF THE INVENTION

1. Field of the Invention

The present invention relates to a combination type fan leaves structure, and more particularly to a fan leaves structure constituted by combining interlacing the leaves of the upper and lower leaves components to form a high density leaves structure.

2. Description of Related Art

Accompanying the development of the computer technology, every kind of current electronic element has a great progress on work execution efficiency. But, that the temperature of the electronic element is too high owing to the increase of power consumption so that the electronic element is overheat, work abnormally or is even damaged. Consequently, a cooling fan has already become a necessary attachment for an electronic device. The air blowing magnitude of the cool fan influences a cooling efficiency directly and the larger the total area is, the more the air blowing magnitude of the cooling fan is. For increasing the total area of the leaves of cooling fan, the phenomenon that the numbers of the leaves are increased is existed in the current market. i.e. the structure of the leaves of a cooling fan in which the density of the leaves is increased as FIG. 1a shows.

Please refer to FIG. 1a. A highly concentrated arrangement way is used in the leaves structure of a conventional cooling fan 1 to increase the total numbers of the leaves and further to increase the total areas of the leaves to attain to the object for increasing the air blowing magnitude of the cooling fan. The highly concentrated arrangement of the leaves of such kind of cooling fan causes the distance between two adjacent leaves to be very small; the manufacturing method for it is to use core and cavity molds with leaves patterns and fabricate it by means of stamping as FIG. 1b shows. But a core mold 1b1 and cavity mold 1b2 must be rotated relatively a proper angle and a mold release can then be processed successfully. Therefore, more procedures must be added in the manufacturing process and the production time and cost are further increased.

Besides, because when such kind of cooling face with rather densely arranged leaves is fabricated through stamping, because it is made by pressing the core mold 1b1 and cavity mold 1b2 together and the release angle must be taken into consideration so as to cause every leaf of the fan structure to unavoidably have a parting line 1a1 thereon. For increasing the eye pleasing of entirety of the fan leaves and comparatively enhance the commercial value thereof, a procedure of the modification of fan leaves must be added in the manufacturing process so that the production and cost are increased.

Inasmuch as a several procedures must be added in the process of fabricating the cooling fan leaves mentioned above so as to increase the production cost and time, the inventor of the present invention has done some research on such kind of fan structure, and then the present invention is proposed.

### SUMMARY OF THE INVENTION

The present invention relates a fan leaves structure; the structure comprises a upper fan leaves component and lower fan leaves component. The feature thereof is that the leaves respectively disposed on the upper and lower fan leaves are formed as a type that they are interlaced each other after the combination of them.

A combination type fan leaves structure according to the present invention is a structure that separate molds are used for respectively fabricating the upper and the lower fan leaves components with a larger interval between two adjacent leaves on each component, and the upper and lower leaves components are then combined into a fan leaves body with a larger density of leaves by interlacing the leaves respectively disposed on them. Besides, because the interval between two adjacent leaves on each leaves component is larger, when the release of molds is process, even if the core and cavity molds need not be rotated, the release can be processed successfully. In addition, because the angle of release need not be taken into consideration when the molds are fabricated, a parting line can be designed not to appear on each leaf so that the work flow of the modification of the surfaces of the leaves and further to lower the production cost.

According to a fan leaves structure of the present invention, the upper leaves component comprises a central cover and a plurality of leaves obliquely disposed with an angle connected on the cover, a portion of the end that the leaves connected to the cover is extended out of the cover, and a plurality of buckling units are disposed at the one edge of the cover used for buckling up with the lower leaves component.

According to a fan leaves structure of the present invention, the lower leaves component comprises a central frame and a plurality of leaves obliquely disposed with an angle connected on the frame, the end that the leaves are connected to the frame is extended out of the frame, and a plurality of buckling units are disposed at the one edge of the frame use for buckling up with the upper leaves component.

According to the structure, when the upper and lower leaves component are combined with each other, the leaves on the upper leaves component extended from the cover can be engaged with the outer edge of the central frame of the lower leaves component, and the leaves on the lower leaves component extended from the frame body can similarly engaged with the outer edge of the central cover of the upper leaves component so that the upper and lower leaves components can be combined with each other by interlacing the leaves respectively disposed on the upper and the lower leaves components. And, the fan leaves according to the present invention is obtained by buckling up the buckling units disposed respectively on the central cover of the upper leaves component and the central frame of the lower leaves component together so as to obtain an fan leaves structure according to the present invention.

According to the fan leaves structure of the present invention, the buckling units can be indented and raised portions, or an indented and raised points for each other, only if male and female components can be formed for each other is enough.

In addition, a fixing seat for fixing a rotating shaft is further disposed at the center part inside the central cover of the upper leaves component in the fan leaves structure according to the present invention. Whereby, the rotating shaft can be connected with a power source and a power can be provided through the power supply for it to be rotated.

The fan leaves according to the present invention, a metal supporting frame can further be installed at the inner edge of the central frame of the fan leaves after assembling, a stronger supporting force is provided on the fan leaves components through the strong characteristic of the metal supporting frame structure to allow the upper fan leave structure and the lower fan leaves of the fan leaves structure according to the present invention to be combined tightly and stably into one body.

### BRIEF DESCRIPTION OF THE DRAWINGS

The present invention can be more fully understood by reference to the following description and accompanying drawings, in which:

FIG. 1a is a prospective view, showing a fan of the prior art;

FIG. 1b is a schematic view, showing a mold release of a fan of the prior art;

FIG. 2 is an explosive view, showing a combination type fan leaves structure of a preferred embodiment according to the present invention; and

FIG. 3 is a cross sectional view, showing a combination type fan leaves structure of a preferred embodiment according to the present invention.

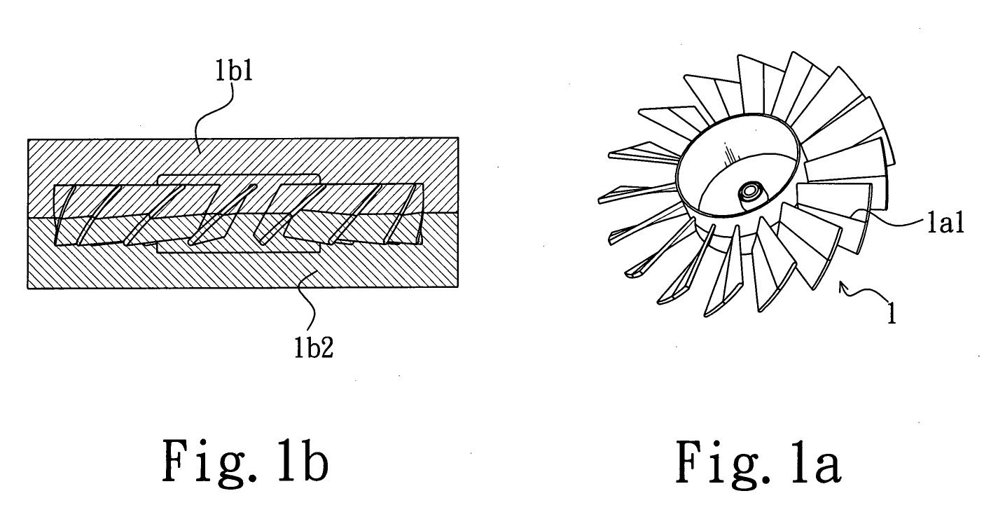

### DETAILED DESCRIPTION OF THE PREFERRED EMBODIMENTS

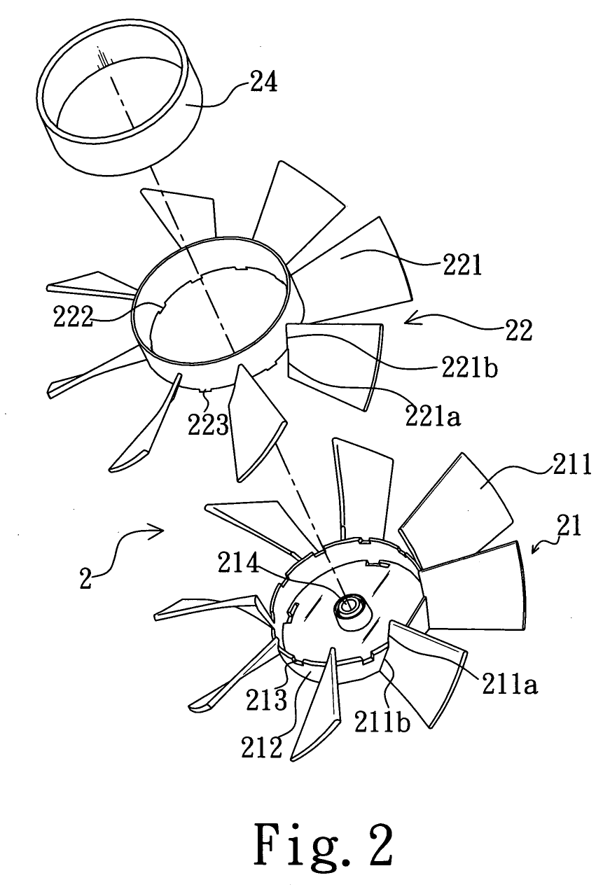

FIG. 2 is an explosive view showing a combination type fan leaves structure of a preferred embodiment according to the present invention, in which 2 is the entirety of the fan leaves structure.

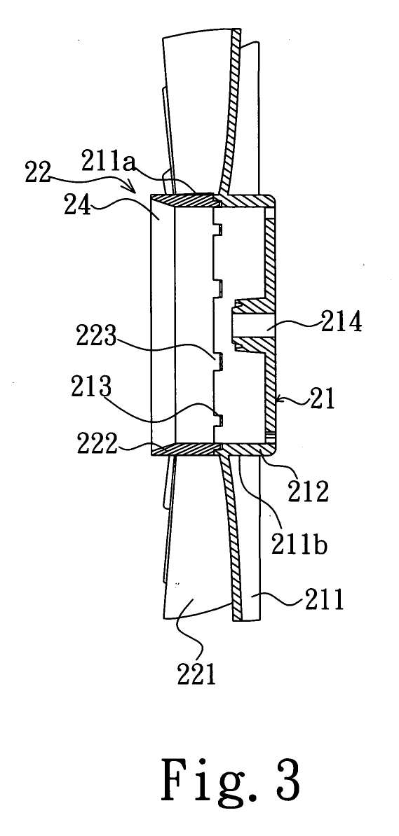

Please refer to FIGS. 2 and 3. The combination type fan leaves structure 2 comprises a upper fan leaves component 21, lower fan leaves component 22 and metal central supporting frame 24, in which the upper fan leaves component 21 further comprises a central cover 212 and fan leaves 211 connected on the central cover 212. One end 211b of each leaf 211 is connected to the cover 212 and another end of 211a is extended from the cover 212 and suspended in midair. A plurality of buckling units 213, which are used for buckling up with the lower fan leaves component 22, are disposed at the edge of the cover 212. Moreover, a fixing seat 214 installed at the center inside of the cover 212 is used for fixing a center shaft that is connected to a power supply (not shown in the figures) for driving the fan leaves structure. The lower fan leaves component 22 further comprises a central frame 222 and leaves 221 connected to the central frame 222. One end 221b of each leaf 221 is connected to the frame 222 and another end of 221a is extended from the frame 222 and suspended in midair. A plurality of buckling units 223, which are used for buckling up the upper fan leaves component 21, are disposed at the edge of the frame 222.

The ends of leaves 211a and 221a respectively disposed on the upper fan leaves components 21 and 22 are engaged each other to the outer rims of the central frame 222 and the central cover 212 so as to be interlaced and arranged each other to combine into the combination type fan leaves structure 2 according to the present invention while assembling.

After the upper and lower leaves components 21 and 22 are buckled together to combine with each other through the buckling units 213 and 223, the central cover 212 and the central frame 222 are combined into one entire frame. A metal supporting frame 24 can be inserted into the entire frame, the dimension of the metal supporting frame 24 is exactly tightly combined with the inner rim so that a sufficient supporting force is provided to allow the upper fan leaves component 21 and the lower fan leaves component 22 to be tightly combined with each other and not to be separated from each other or a shake not to be caused in the entire frame. Furthermore, an adhesive can also be applied at the combination part of the metal supporting frame 24 and the inner rim of the entire frame to allow the upper fan leaves components 21 and 22 to be combined more stably.

In this preferred embodiment, although metal is used as a material of the metal supporting frame 24, but a material with an enough supporting force to allow the upper and lower fan leaves components 21 and 22 to be able to obtain a sufficient support can also be used. Moreover, whether the metal supporting frame 24 is existed or not is not used to limit the present invention, only if the upper and lower fan leaves components 21 and 22 can be tightly combined with each other together not to separate to change a location and shake, the extra installment of the metal supporting frame 24 is unnecessary.

A fan leaves body formed by combining the upper and the lower fan leaves components 21 and 22 together by interlacing each other can be made as a cooling fan with a denser leaves arrangement. And, because the upper and lower fan leaves components are respectively fabricated to the components with smaller density of leaves in the process of producing such kind of the fan, the core and cavity need not to be separated by rotating a proper angle in the process of release so as to attain to the object of the easier production. Moreover, because the angle of release is not needed to consider when the molds of the leaves is fabricated, the leaves without a parting line thereon can be designed and a work flow of the modification of the outlook of the leaves can be avoided so that the production cost can be lowered. Therefore, the production efficiency can be enhanced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A fan leaves structure, comprising:
a upper fan leaves component, comprising a central cover and a plurality of leaves disposed on said central cover with an oblique angle;
a lower fan leaves component, comprising a central frame and a plurality of leaves disposed on said central frame with an oblique angle;
Said upper and lower fan leaves combined together by connecting said central cover and said central frame and interlacing said leaves respectively disposed on said upper and lower fan leaves components.

2. The fan leaves structure according to claim 1, wherein a part of one end of each said leaf connected to said central cover in said upper fan leaves component is extended out of said central cover and a plurality of buckling units are disposed at one rim of said central cover for being buckled with said lower fan leaves component.

3. The fan leaves structure according to claim 1, wherein a part of one end of each said leaf connected to said central frame in said lower fan leaves component is extended out of said central frame and a plurality of buckling units are disposed at one rim of said central frame for being buckled with said upper fan leaves component.

4. The fan leaves structure according to claim 1, a fixing seat further installed at the central part inside of said central cover.

5. The fan leaves structure according to claim 1, a ring type supporting frame further installed at the inner rim of said fan leaves structure.

6. The fan leaves structure according to claim 5, wherein said supporting frame is made from metal.
